(19) United States
(12) Patent Application Publication
(10) Pub. No.: US 2025/0252171 A1
(43) Pub. Date: Aug. 7, 2025

(54) BIOMETRIC AUTHENTICATION APPARATUS, BIOMETRIC AUTHENTICATION METHOD, AND COMPUTER READABLE MEDIUM

(71) Applicant: Mitsubishi Electric Corporation, Tokyo (JP)

(72) Inventor: Shun HINATSU, Tokyo (JP)

(73) Assignee: Mitsubishi Electric Corporation, Tokyo (JP)

(21) Appl. No.: 19/191,590

(22) Filed: Apr. 28, 2025

Related U.S. Application Data
(63) Continuation of application No. PCT/JP2022/046631, filed on Dec. 19, 2022.

(51) Int. Cl. G06F 21/32; G06V 40/20; G06V 40/40

(52) U.S. Cl. CPC G06F 21/32; G06V 40/28; G06V 40/45

(57) ABSTRACT

A measurement unit (21) measures biometric information of an authentication subject by a sensor. An authentication information processing unit (22) generates from the biometric information acquired by the measurement unit (21), authentication information that varies depending on the individual living body, and determines the propriety of authentication based on whether or not the authentication information satisfies an authentication condition. A mental and physical state estimation unit (23) generates from the biometric information, mental and physical information for estimating a mental and physical state of the authentication subject, and estimates the mental and physical state from the mental and physical information. An authentication condition update unit (24) changes the authentication condition depending on the mental and physical state estimated by the mental and physical state estimation unit (23).

### CROSS REFERENCE TO RELATED APPLICATION

This application is a Continuation of PCT International Application No. PCT/JP2022/046631, filed on Dec. 19, 2022, which is hereby expressly incorporated by reference into the present application.

### TECHNICAL FIELD

The present disclosure relates to a technology for performing authentication based on biometric information.

### BACKGROUND ART

With the proliferation of devices such as PCs and smartphones, the proliferation of biometric authentication provided through these devices has also progressed. PC is an abbreviation for Personal Computer.

Many methods of biometric authentication are image-based. The many methods of biometric authentication, use biometric information such as a face, fingerprint, or iris for authentication.

In recent years, with the proliferation of wearable devices, research and development of biometric authentication methods based on biometric signals, which are time-series signals, has progressed. For example, a biometric signal such as an electrocardiogram (ECG), photoplethysmogram (PPG), or electroencephalogram (EEG) is used. ECG is an abbreviation for ElectroCardioGram. PPG is an abbreviation for PhotoPlethysmoGram. EEG is an abbreviation for ElectroEncephaloGram.

In the case of biometric authentication, the technology used to verify the legitimacy of an authentication subject is not sufficient. The authentication subject is a subject to be measured by a sensor. Verifying the legitimacy of an authentication subject means verifying whether or not the authentication subject is appropriate as a subject to be authenticated.

For example, it is assumed that a person who is the authentication subject performs device operation, such as driving an automobile, after authentication. In this case, verifying the legitimacy of an authentication subject means verifying whether or not the person who is the authentication subject is appropriate as a person who performs the device operation. Specifically, in this case, it is necessary to verify whether or not the measurement subject has not been replaced by another person after authentication, whether or not the measurement subject is really a living body, whether or not the health state of the subject is appropriate, and the like. Verifying whether or not the measurement subject is really a living body means verifying whether or not a forged signal has not been input. Verifying whether or not the health state of the subject is appropriate means verifying such things as the presence or absence of consciousness and intoxication.

In particular, compared to image-based authentication, signal-based authentication is not sufficient in terms of the legitimacy verification technology described above. With regard to facial authentication, which is image-based authentication, a feasible technique for the legitimacy verification described above has been proposed according to a method in which a camera has been combined with another sensor, or a method of extracting the necessary information through image processing. With regard to signal-based authentication, Patent Literature 1 describes utilizing the fact that the information used for authentication is a time-series signal, and repeating the authentication process to verify whether or not the measurement subject has been replaced by another person after authentication.

### Citation List

### Patent Literature

Patent Literature 1: International Publication No. 2021/140588

### SUMMARY OF INVENTION

### Technical Problem

When the device operation is performed after authentication, it is necessary to verify not only whether or not the measurement subject has been replaced by another person after authentication, but also whether or not the measurement subject is really a living body, whether or not the health state of the subject is appropriate, and the like. However, in conventional signal-based authentication, these verifications are not performed, and it cannot be said that the verification of the validity of the authentication subject is sufficiently performed. As a result, authentication is performed in a state where the authentication subject is not appropriate as a subject to be authenticated, and it causes a state in which the device operation is possible.

The present disclosure aims to enable an authentication subject, as a subject to be authenticated, to control a device in order to operate the device in a more appropriate state.

### Solution to Problems

A biometric authentication apparatus according to the present disclosure includes:
a measurement unit to measure biometric information of an authentication subject by a sensor;
an authentication information processing unit to generate from the biometric information acquired by the measurement unit, authentication information that varies depending on the individual living body, and to determine the propriety of authentication based on whether or not the authentication information satisfies an authentication condition;
a mental and physical state estimation unit to generate from the biometric information, mental and physical information for estimating a mental and physical state of the authentication subject, and to estimate the mental and physical state form the mental and physical information; and
an authentication condition update unit to change the authentication condition depending on the mental and physical state estimated by the mental and physical state estimation unit.

### Advantageous Effects of Invention

In the present disclosure, mental and physical information is generated from biometric information to estimate a mental and physical state, and an authentication condition is changed depending on the estimated mental and physical state. This makes it possible to determine the propriety of authentication taking into account the mental and physical state. As a result, it enables an authentication subject, as a subject to be authenticated, to control a device in order to operate the device in a more appropriate state.

### BRIEF DESCRIPTION OF DRAWINGS

FIG. 1 is a configuration diagram of a biometric authentication apparatus 10 according to Embodiment 1.

FIG. 2 is an explanatory diagram of information stored in a database according to Embodiment 1.

FIG. 3 is an explanatory diagram of information stored in the database according to Embodiment 1.

FIG. 4 is an explanatory diagram of processing of a general authentication method.

FIG. 5 is a flowchart illustrating a processing flow of the biometric authentication apparatus 10 according to Embodiment 1.

FIG. 6 is an explanatory diagram of mental and physical information in a case where a physical condition is estimated according to Embodiment 1.

FIG. 7 is an explanatory diagram of mental and physical state estimation in a case where the physical condition is estimated according to Embodiment 1.

FIG. 8 is an explanatory diagram of the mental and physical information in a case where an attachment state of a sensor is estimated according to Embodiment 1.

FIG. 9 is an explanatory diagram of the mental and physical state estimation in a case where the attachment state of the sensor is estimated according to Embodiment 1.

FIG. 10 is a configuration diagram of the biometric authentication apparatus 10 according to Embodiment 2.

FIG. 11 is an explanatory diagram of information stored in the database according to Embodiment 2.

FIG. 12 is a flowchart illustrating a processing flow of the biometric authentication apparatus 10 according to Embodiment 2.

FIG. 13 is an explanatory diagram of movement information in a case where a finger gripping movement is required according to Embodiment 2.

FIG. 14 is an explanatory diagram of the movement information in a case where a breathing movement is required according to Embodiment 2.

FIG. 15 is a configuration diagram of the biometric authentication apparatus 10 according to Embodiment 3.

FIG. 16 is an explanatory diagram of information stored in the database according to Embodiment 3.

FIG. 17 is a flowchart illustrating a processing flow of the biometric authentication apparatus 10 according to Embodiment 3.

FIG. 18 is an explanatory diagram of measurement information in a case where a current amount is reduced according to Embodiment 3.

FIG. 19 is an explanatory diagram of the measurement information in a case where a light source wavelength is changed according to Embodiment 3.

### DESCRIPTION OF EMBODIMENTS

### EMBODIMENT 1

### Description of Configuration

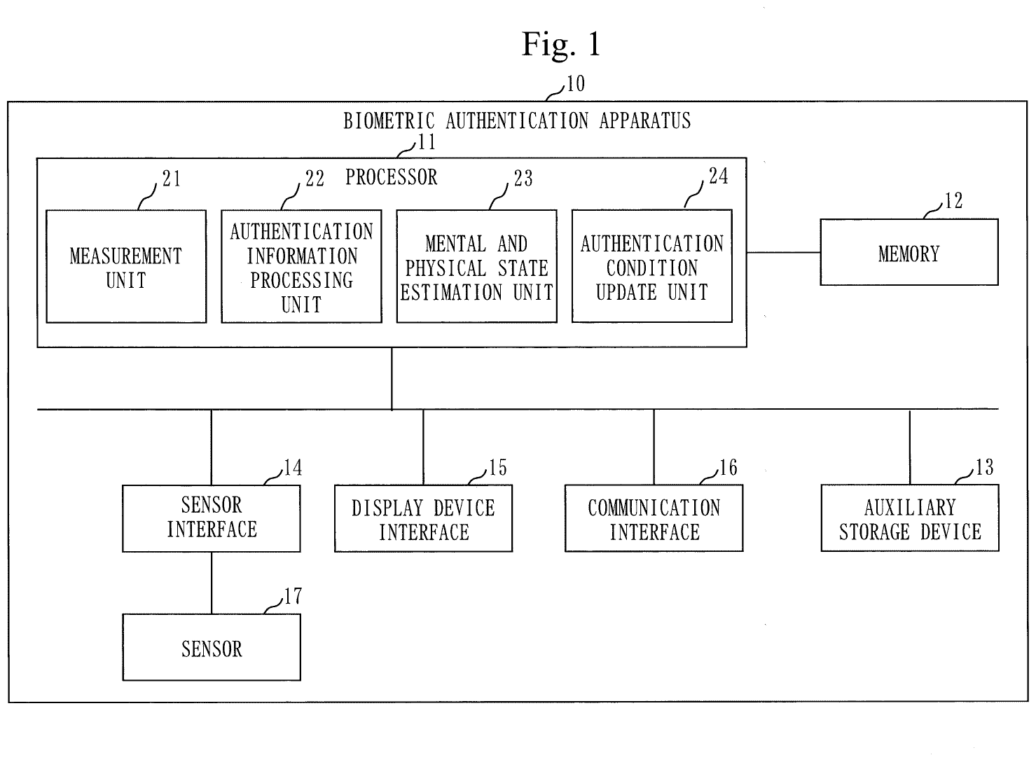

Referring to FIG. 1, the configuration of a biometric authentication apparatus 10 according to Embodiment 1 will be described.

The biometric authentication apparatus 10 is a computer. The biometric authentication apparatus 10 is a wearable device provided with a sensor capable of acquiring biometric information. The wearable device may take any form such as a clothing type, a wristwatch type, a hat type, a ring type, or a glasses type. Alternatively, the biometric authentication apparatus 10 may be a mobile device such as a smartphone or a tablet terminal. Alternatively, the biometric authentication apparatus 10 may be an installation type device provided with a camera or the like. The physical appearance and configuration of the biometric authentication apparatus 10 is not limited to these.

The biometric authentication apparatus 10 includes a processor 11, a memory 12, an auxiliary storage device 13, a sensor interface 14, a display device interface 15, and a communication interface 16. The processor 11 is connected to other pieces of hardware via signal lines, and controls these other pieces of hardware.

The processor 11 is an IC that performs processing. IC stands for Integrated Circuit. The processor 11 is, as a specific example, a CPU, a DSP, or a GPU. CPU is an abbreviation for Central Processing Unit. DSP is an abbreviation for Digital Signal Processor. GPU is an abbreviation for Graphics Processing Unit.

The memory 12 is a storage device to temporarily store data. The memory 12 is, as a specific example, an SRAM or a DRAM. SRAM is an abbreviation for Static Random Access Memory. DRAM is an abbreviation for Dynamic Random Access Memory.

The auxiliary storage device 13 is a storage device to store data. The auxiliary storage device 13 is, as a specific example, is an HDD. HDD is an abbreviation for Hard Disk Drive. Additionally, the auxiliary storage device 13 may also be a portable recording medium such as an SD (registered trademark) memory card, CompactFlash (registered trademark), NAND flash, a flexible disk, an optical disc, a compact disc, a Blu-ray (registered trademark) disc, or a DVD. SD is an abbreviation for Secure Digital. DVD is an abbreviation for Digital Versatile Disk.

The sensor interface 14 is an interface to communicate with a sensor 17. The sensor 17 is a device that acquires biometric information of a user. The sensor interface 14 is, as a specific example, a USB port. USB is an abbreviation for Universal Serial Bus.

In FIG. 1, the biometric authentication apparatus 10 is configured to include the sensor 17. However, the sensor 17 may be provided externally to the biometric authentication apparatus 10.

The display device interface 15 is an interface to communicate with a display device that displays such as information of a processing result. The display device interface 15 is, as a specific example, an HDMI (registered trademark) port. HDMI is an abbreviation for High-Definition Multimedia Interface.

The communication interface 16 is an interface to communicate with external devices. The communication interface 16 is, as a specific example, an Ethernet (registered trademark) port or a wireless communication antenna.

In FIG. 1, the sensor 17 is connected to the processor 11 via the sensor interface 14. However, it is also conceivable that the sensor 17 is provided externally to the biometric authentication apparatus 10 and connected via wireless communication. In this case, the sensor 17 is connected to the processor 11 via the communication interface 16.

The sensor 17 acquires biometric information (biological signals) that are acquired in a time series manner. Specifically, the biometric information includes biological signals such as ECG, PPG, EEG, electromyogram, and electrooculogram, which can be measured subconsciously with a wearable device, but is not limited to a specific signal. In the following description, PPG, which is optically measured and derived from the behavior of the heart or blood vessels, is used as an example unless otherwise noted.

The biometric authentication apparatus 10 includes, as functional components, a measurement unit 21, an authentication information processing unit 22, a mental and physical state estimation unit 23, and an authentication condition update unit 24. The functions of the individual functional components of the biometric authentication apparatus 10 are implemented by software.

The auxiliary storage device 13 stores a program that implements the functions of the individual functional components of the biometric authentication apparatus 10. This program is loaded into the memory 12 by the processor 11 and executed by the processor 11. Thus, the functions of the individual functional components of the biometric authentication apparatus 10 are implemented.

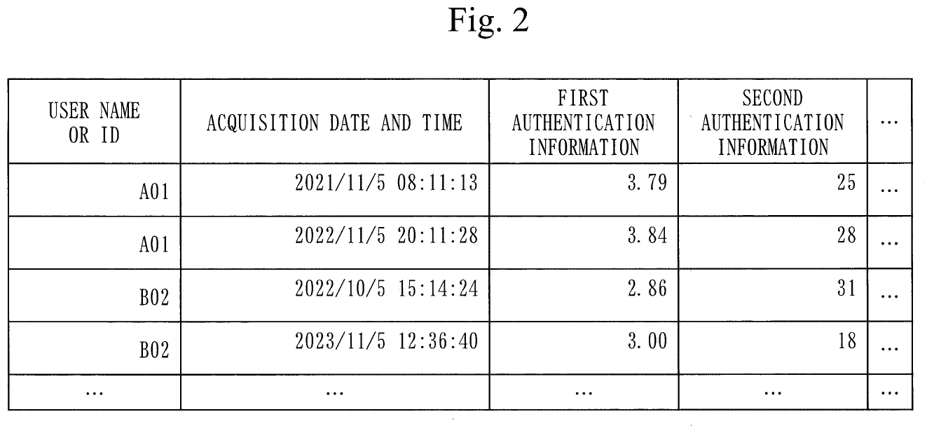

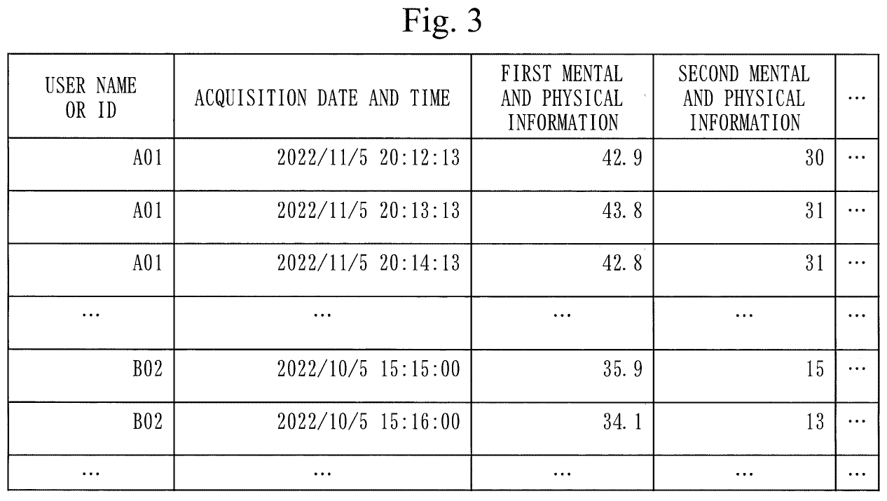

The memory 12 or the auxiliary storage device 13 implements a database that stores such as information obtained from the biometric information acquired by the sensor 17. For example, as illustrated in FIG. 2, the database stores first authentication information, second authentication information, and the like generated from the biometric information for each user and acquisition date and time. Also, as illustrated in FIG. 3, the database stores first mental and physical information, second mental and physical information, and the like generated from the biometric information for each user and acquisition date and time. The tables illustrated in FIGS. 2 and 3 may be combined into a single table.

The database described above may be implemented in a distributed manner in the memory 12 and the auxiliary storage device 13. Furthermore, FIG. 2 illustrates the format in which the data is stored in tabular form. However, the format of the database is not limited to this, and NoSQL may be used.

FIG. 1 illustrates only one processor 11. However, there may be a plurality of processors 11, and the plurality of processors 11 may execute the program that implements each function in cooperation.

Similarly, FIG. 1 illustrates only one sensor 17. However, there may be a plurality of sensors 17. For example, the biometric authentication apparatus 10 may include different types of sensors, such as a PPG sensor and an ECG sensor (electrode), as the sensors 17, or may include two or more pieces of the same sensors, such as PPG sensors.

### Description of Operation

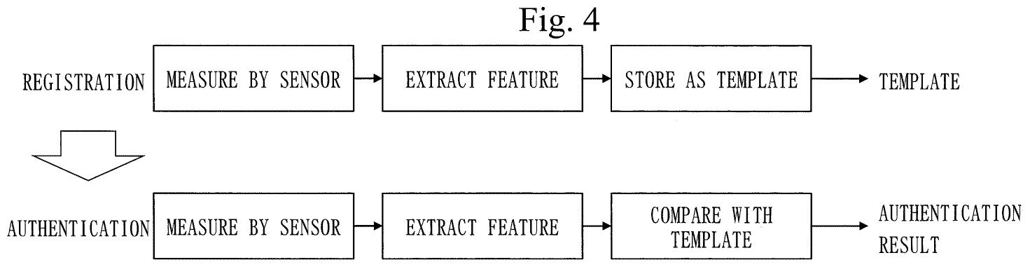

Referring to FIGS. 4 to 9, the operation of the biometric authentication apparatus 10 according to Embodiment 1 will be described.

An operation procedure of the biometric authentication apparatus 10 according to Embodiment 1 is equivalent to a biometric authentication method according to Embodiment 1. Also, a program that implements the operation of the biometric authentication apparatus 10 according to Embodiment 1 is equivalent to a biometric authentication program according to Embodiment 1.

The biometric authentication apparatus 10 performs authentication using the periodicity of biological signals. In this process, the biometric authentication apparatus 10 implements biometric authentication that includes determination of whether or not to continue the authentication state or to permit subsequent device operation taking into account a mental and physical state of a subject.

Referring to FIG. 4, the processing of a general authentication method will be described.

In FIG. 4, the processing procedure of the authentication method includes processing at the time of registration and processing at the time of authentication.

At the time of registration, (1) measurement is performed by the sensor. (2) A feature is extracted from measurement information. (3) The extracted feature is stored as a template.

At the time of authentication, (1) measurement is performed by the sensor. (2) A feature is extracted from the measurement information. (3) The extracted feature is compared with the template stored at the time of registration, and the propriety of the authentication is determined.

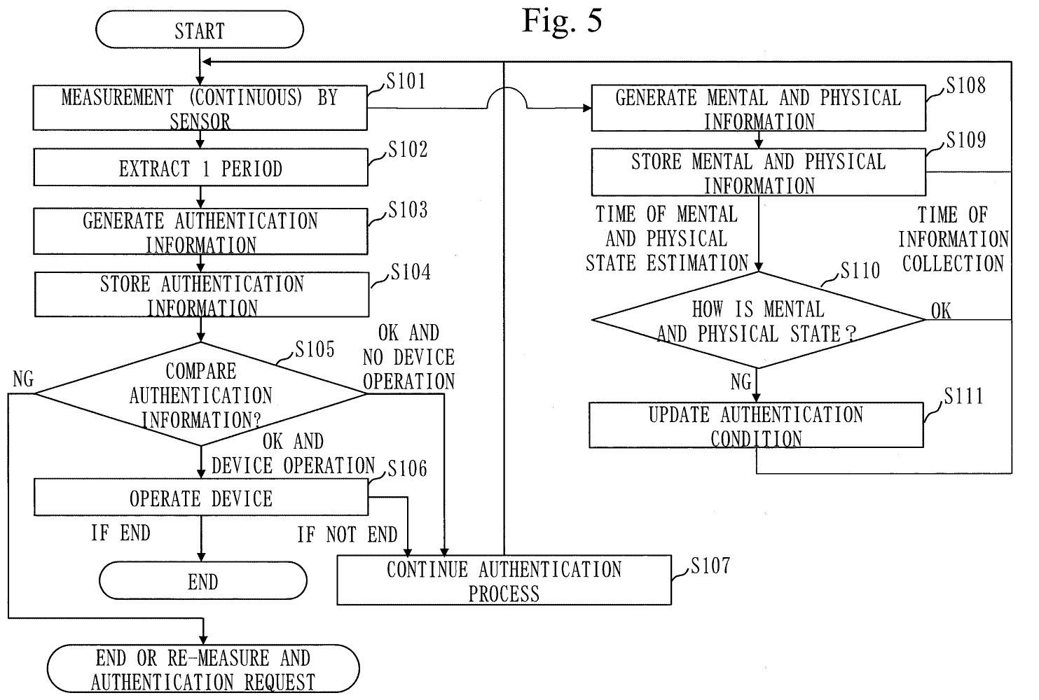

Referring to FIG. 5, a processing flow of the biometric authentication apparatus 10 according to Embodiment 1 will be described.

In Embodiment 1, an example will be described that extends the processing of the authentication method illustrated in FIG. 4. However, the biometric authentication apparatus 10 is not intended to extend any specific existing authentication method, and the processing illustrated in FIG. 4 is only an example. Here, it is assumed that the processing at the time of registration illustrated in FIG. 4 has been executed in advance.

### Step S101: Measurement Process

The measurement unit 21 continuously measures the biometric information of the authentication subject using the sensor 17. To continuously measure means to measure at very short time intervals.

The processes from steps S102 to S107 and the processes from steps S108 to S111 are repeatedly executed in parallel. The processes from steps S108 to S111 are repeatedly executed at observation intervals independent of periods of the biometric signals. Here, the processes from steps S108 to S111 are repeatedly executed at every infinitesimal time, such as one-second intervals, which is shorter than the periods of the biometric signals.

### Step S102: Period Extraction Process

The authentication information processing unit 22 extracts a signal for a specific period that constitutes the biometric signals, which is the biometric information measured in step S101, at a specific timing such as the start of measurement or the time of device operation.

Specifically, the authentication information processing unit 22 focuses on features such as the periodicity, the maximum and minimum values, and the like of the biometric signals to extract a waveform that conforms to or is similar to a specific shape. Alternatively, the authentication information processing unit 22 may extract signal waveforms for a specific time such as one second or one minute.

### Step S103: Authentication Information Generation Process

The authentication information processing unit 22 generates from the signals for specific periods extracted in step S102, authentication information that varies depending on the individual of a living body. The authentication information processing unit 22 may use the entire signals for specific periods as the authentication information, or may acquire some information from the signals for specific periods, as features to be used as the authentication information.

### Step S104: Authentication Information Storage Process

The authentication information processing unit 22 stores the authentication information generated in step S103 in the database as illustrated in FIG. 2.

### Step S105: Authentication Determination Process

The authentication information processing unit 22 determines whether or not the authentication information generated in step S103 satisfies an authentication condition. Thus, the authentication information processing unit 22 determines the propriety of the authentication for the authentication subject. When the authentication information satisfies the authentication condition, the authentication information processing unit 22 recognizes the authentication subject as a legitimate authentication subject, and authenticates the authentication subject. On the other hand, when the authentication information does not satisfy the authentication condition, the authentication information processing unit 22 does not recognize the authentication subject as a legitimate authentication subject, and does not authenticate the authentication subject.

In Embodiment 1, the authentication information processing unit 22 compares the template stored in the database with the authentication information generated in step S103. When a difference between the template and the authentication information is within a range specified in the authentication condition, the authentication information processing unit 22 determines that the authentication condition is satisfied. On the other hand, when the difference between the template and the authentication information is outside the range specified in the authentication condition, the authentication information processing unit 22 determines that the authentication condition is not satisfied.

When authentication is possible and there is device operation, the authentication information processing unit 22 proceeds with the process to step S106. When authentication is possible and there is no device operation, the authentication information processing unit 22 proceeds with the process to step S107. When authentication is not possible, the authentication information processing unit 22 ends the process. Additionally, when authentication is not possible, the authentication information processing unit 22 may accept a re-authentication request and restart the process from step S101.

The processes from steps S101 to S105 correspond to the processes at the time of the authentication illustrated in FIG. 4.

### Step S106: Device Operation Process

Device operation is performed by the authentication subject. Thereafter, when the device operation is to be continued, the process proceeds to step S107. On the other hand, when the device operation ends, the process ends.

### Step S107: Authentication Continuation Process

The authentication information processing unit 22 returns the process to step S101 to continue the authentication process.

### Step S108: Mental and Physical Information Generation Process

The mental and physical state estimation unit 23 generates from the biometric information measured in step S101, mental and physical information to estimate the mental and physical state of the authentication subject. The mental and physical information is information that varies non-periodically (in the long term) independent of the period of the biometric information. A specific example of the mental and physical information will be described later.

### Step S109: Mental and Physical Information Storage Process

The mental and physical state estimation unit 23 stores the mental and physical information generated in step S108 in the database as illustrated in FIG. 3.

When an observation time has elapsed after executing the process of step S110, the mental and physical state estimation unit 23 proceeds with the process to step S110. On the other hand, when the observation time has not elapsed after executing the process of step S110, the mental and physical state estimation unit 23 returns the process to step S101. Whether or not the observation time has elapsed may be specified by whether or not the process of step S109 has been executed a fixed number of times.

### Step S110: Mental and Physical State Estimation Process

The mental and physical state estimation unit 23 estimates from the mental and physical information stored in the database in step S109, the mental and physical state of the authentication subject. The method of estimating the mental and physical state will be described later.

When the estimated mental and physical state is good, the mental and physical state estimation unit 23 returns the process to step S101. On the other hand, when the estimated mental and physical state is poor, the mental and physical state estimation unit 23 proceeds with the process to step S111.

### Step S111: Authentication Condition Update Process

The authentication condition update unit 24 changes the authentication condition used in step S105 depending on the mental and physical state. Here, since the mental and physical state is poor, the authentication condition update unit 24 makes the authentication condition to be strict.

Then, the authentication condition update unit 24 returns the process to step S101.

Specific examples of the mental and physical information generated in step S108, the method of estimating the mental and physical state in step S110, and the method of changing the authentication condition in step S111 will be described.

Two examples of (a) and (b) will be described here. The biometric authentication apparatus 10 selects and uses one of (a) and (b), whichever is appropriate for the biometric information. Alternatively, the biometric authentication apparatus 10 may use (a) and (b) in combination.

In the two examples of (a) and (b), it is assumed that the processes illustrated from steps S101 to S105 are performed at the start of measurement or before specific device operation or the like, and when it is determined that the subject is a legitimate person, the authentication state is continued, and the measurement is repeated.

### (a) Estimation of Physical Condition

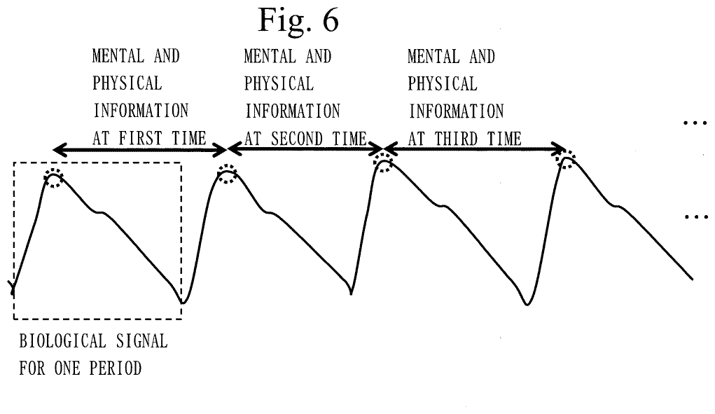

In (a), the mental and physical state estimation unit 23 estimates the physical condition of the authentication subject as the mental and physical state of the authentication subject. As illustrated in FIG. 6, from steps S108 to S109, the mental and physical state estimation unit 23 extracts and stores a distance (time) between each period, which is obtained by focusing on the maximum value in one period of the biometric information, as the mental and physical information. After repeating this process and the observation time has elapsed, the mental and physical state estimation unit 23 estimates from the mental and physical information stored in the database, the physical condition of the authentication subject, in step S110.

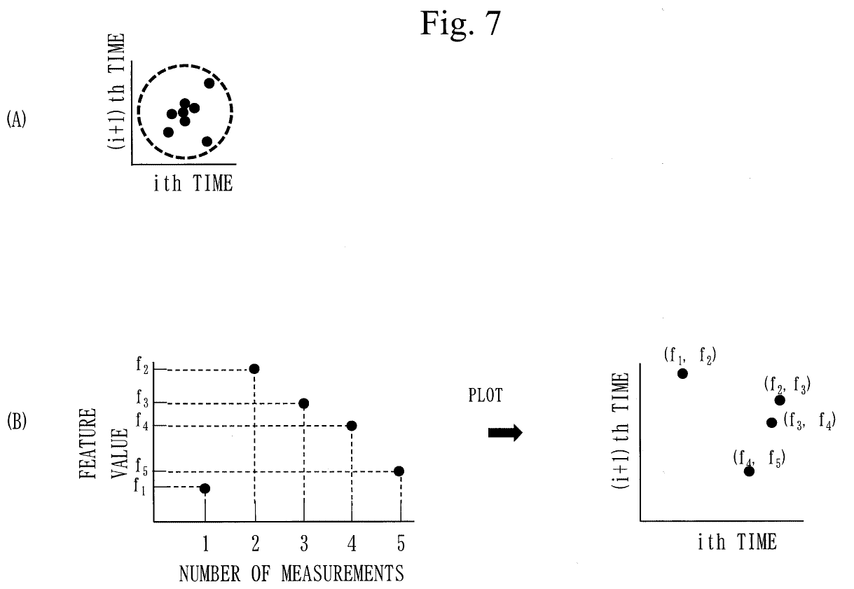

In step S110, the mental and physical state estimation unit 23 estimates the mental and physical state of the authentication subject based on the mental and physical information generated in each time (i=1, 2, . . . , n). For example, as illustrated in FIG. 7 (A), the mental and physical information generated in each time (i=1, 2, . . . , n) is plotted on the coordinates for i=1, . . . , n−1. In the following, the physical condition of the authentication subject, especially a relaxed state, is given as the mental and physical state to be estimated. However, a subject of estimation is not limited to being in a specific state. Also, although an example of plotting the mental and physical information on two-dimensional coordinates (i, i+1) will be described, it is not limited to specific dimensions.

As illustrated in FIG. 7 (B), it is assumed that the mental and physical information generated five times is f1, f2, f3, f4, and f5. In this case, plotting is performed for each i where i=1, . . . , 4. Specifically, the coordinates (f1, f2) are plotted for i=1. The coordinates (f2, f3) are plotted for i=2. The coordinates (f3, f4) are plotted for i=3. The coordinates (f4, f5) are plotted for i=4.

Then, the mental and physical state estimation unit 23 determines the relaxed state of the subject by checking the values of the mental and physical information. For example, the mental and physical state estimation unit 23 determines the relaxed state of the subject by the radius of the smallest circle that encloses all the plotted points as the variance of the mental and physical information. For example, when the heart rate is in the midst of an increase due to exertion, the variance is large. Specifically, since the difference between the first and second feature values, the difference between the second and third feature values, the difference between the third and fourth feature values, . . . , are large, the variance is large. However, when the heart rate increases to a certain value, the difference in the feature values between different numbers of times does not change much, and the variance is considered to be small. Therefore, criteria may be set to determine the relaxed state taking this point into account.

When the subject is estimated to be relaxed, the mental and physical state estimation unit 23 considers the physical condition to be good (OK in step S110) and keeps the authentication condition as the initial condition. On the other hand, when the subject is not relaxed, the mental and physical state estimation unit 23 considers the physical condition to be poor (NG in step S110) and determines that there is a difficult possibility to continue the authentication state or to permit the device operation, and proceeds with the process to step S111. Then, in step S111, the authentication condition update unit 24 changes the authentication condition to a stricter condition than the initial condition. For example, the authentication condition update unit 24 reduces an allowable difference, which is a range that allows a difference between the template and the authentication information. Alternatively, when the device operation cannot be permitted, the authentication condition update unit 24 may terminate the authentication state.

### (b) Estimation of Attachment State of Sensor

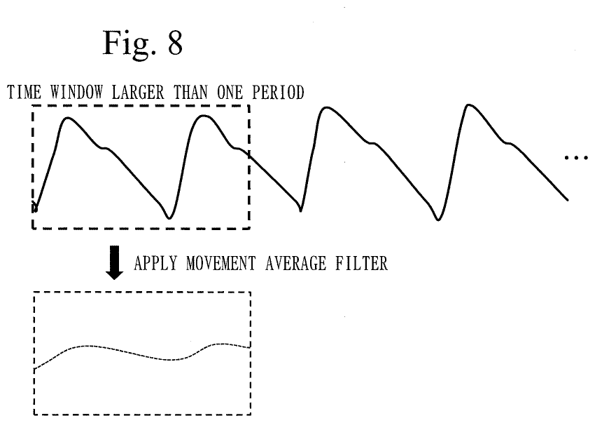

In (b), the mental and physical state estimation unit 23 estimates an attachment state of the sensor for the authentication subject as the mental and physical state of the authentication subject. Here, the attachment state refers to a contact state of the sensor. From steps S108 to S109, (1) as with (a), the mental and physical state estimation unit 23 extracts and stores a distance (time) between each period, which is obtained by focusing on the maximum value in one period of the biometric information, as the mental and physical information. Alternatively, (2) as illustrated in FIG. 8, in a time window which is larger than one period, the mental and physical state estimation unit 23 continuously extracts and stores a moving average within the time window by slightly shifting the time, as the mental and physical information. After repeating the process of (1) or (2) and the observation time has elapsed, the mental and physical state estimation unit 23 estimates the attachment state of the subject from the mental and physical information stored in the database, in step S110.

In step S110, when the distance between each period is used as the mental and physical information as with (a), the mental and physical state estimation unit 23 estimates the mental and physical state of the authentication subject based on the mental and physical information generated in each time (i=1, 2, . . . , n). For example, as illustrated in FIG. 7, the mental and physical information generated in each time (i=1, 2, . . . , n) is plotted on the coordinates for i=1, . . . , n−1. Then, the mental and physical state estimation unit 23 specifies a change in the contact state of the sensor by checking the values of the mental and physical information. For example, by checking the variance of the mental and physical information, the change in the state is specified. When the variance is large, it is considered that measurement values are irregular or deviate from normal values to be measured, and that there is a possibility that the contact state of the sensor is poor (loosely attached). Conversely, when the variance is small, it is considered that the measurement values are stable within a range of values normally measured, and that the contact state of the sensor is good.

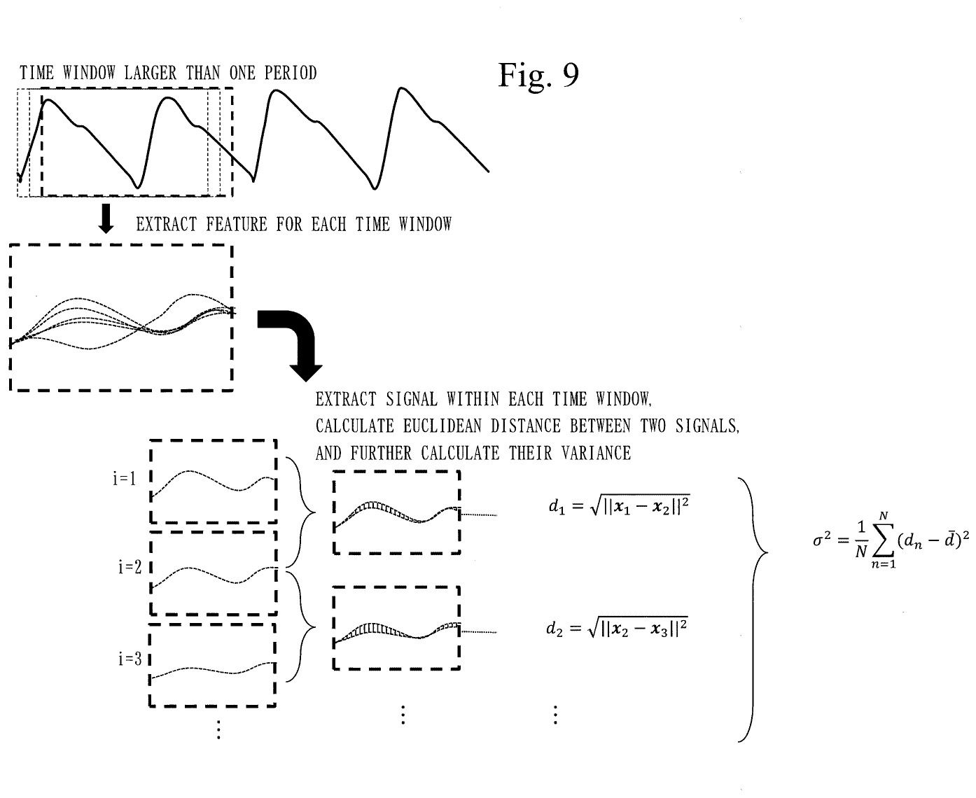

When the moving average within the time window is used as the mental and physical information, the mental and physical state estimation unit 23 calculates the moving average within each time window and specifies the change in the contact state that does not depend on periodic components such as heartbeat and respiration by comparing waveforms of the moving averages, as illustrated in FIG. 9. At this time, the mental and physical state estimation unit 23 calculates an indicator such as Euclidean distance to compare the waveforms between each time window. For example, when there are time windows i=1, . . . , n, the mental and physical state estimation unit 23 compares the waveforms between the time window i and the time window i+1 for each i where i=1, . . . , n−1, based on the indicator. The indicator is not limited to Euclidean distance, but the mental and physical state estimation unit 23 may use an indicator such as an error, a correlation coefficient, a cosine similarity degree, Mahalanobis distance, or Dynamic Time Warping, between the time windows. When the change in the waveforms between the time windows is large, it is considered that there is a possibility that the contact state of the sensor is poor (loosely attached). Conversely, when the change in the waveforms between the time windows is small, it is considered that the measurement values are stable, and that the contact state of the sensor is good.

When the attachment state of the sensor is estimated to be good (OK in step S110), the mental and physical state estimation unit 23 maintains the authentication condition as the initial condition. On the other hand, when the contact state of the sensor is estimated to be poor (NG in step S110), the mental and physical state estimation unit 23 determines that there is a possibility that the measurement is not being performed correctly and that it may be difficult to continue the authentication state or to permit the device operation, and proceeds with the process to step S111. Then, in step S111, the authentication condition update unit 24 changes the authentication condition to a stricter condition than the initial condition. For example, the authentication condition update unit 24 reduces an allowable difference, which is a range that allows a difference between the template and the authentication information. Alternatively, when the device operation cannot be permitted, the authentication condition update unit 24 may terminate the authentication state.

In the above description, when the mental and physical state is poor, the authentication condition update unit 24 changes the authentication condition to be strict, in step S111. However, when the mental and physical state is good, the authentication condition update unit 24 may change the authentication condition to be lenient, in step S111. In other words, when the physical condition is good as in the example of (a), or when the attachment state is good as in the example of (b), the authentication condition may be changed to be lenient in step S111.

In this case, in step S110, when the mental and physical state has changed from the time of the previous determination, the mental and physical state estimation unit 23 proceeds with the process to step S111. Then, in step S111, the authentication condition update unit 24 changes the authentication condition to be lenient when the mental and physical state is better than that in the previous time, and to be strict when the mental and physical state is worse than that in the previous time.

Also, in the above description, the authentication condition update unit 24 has changed the authentication condition. However, the authentication condition update unit 24 may change the authentication information generated in step S103, in addition to or instead of the authentication condition.

### Effects of Embodiment 1

As described above, the biometric authentication apparatus 10 according to Embodiment 1 generates mental and physical information, and estimates a mental and physical state of an authentication subject. Then, the biometric authentication apparatus 10 changes an authentication condition depending on the mental and physical state. Thus, the propriety of authentication is determined taking into account the mental and physical state. In other words, by making the authentication condition stricter or, conversely, more lenient depending on the mental and physical state, it is possible to implement biometric authentication that takes into account changes in biometric signals based on the passage of time, health condition, body movement during device operation, and the like. As a result, it enables an authentication subject, as a subject to be authenticated, to control a device in order to operate the device in a more appropriate state.

### Other Configurations

### Modification 1

In Embodiment 1, the individual functional components are implemented by software. However, Modification 1 may be possible where the individual functional components are implemented by hardware. Modification 1 will be described in terms of differences from Embodiment 1.

When the individual functional components are implemented by hardware, the biometric authentication apparatus 10 includes an electronic circuit instead of the processor 11, the memory 12, and the auxiliary storage device 13. The electronic circuit is a dedicated circuit that implements the functions of the individual functional components and the functions of the memory 12 and the auxiliary storage device 13.

A single circuit, a composite circuit, a programmed processor, a parallel-programmed processor, a logic IC, a GA, an ASIC, and an FPGA may be employed as the electronic circuit. GA is an abbreviation for Gate Array. ASIC is an abbreviation for Application Specific Integrated Circuit. FPGA is an abbreviation for Field-Programmable Gate Array.

The individual functional components may be implemented by one electronic circuit, or may be implemented by a plurality of electronic circuits through distribution.

### Modification 2

Modification 2 may be possible where some of the functional components are implemented by hardware and the remaining functional components are implemented by software.

The processor 11, the memory 12, the auxiliary storage device 13, and the electronic circuit are referred to as processing circuitry. In other words, the functions of the individual functional components are implemented by the processing circuitry.

### EMBODIMENT 2

Embodiment 2 differs from Embodiment 1 in that it is determined whether or not the authentication subject is a living body based on whether or not the biometric information resulting from a specific movement is measured, and the authentication condition is changed. In Embodiment 2, this difference will be described, and the description of the same points will be omitted.

### Description of Configuration

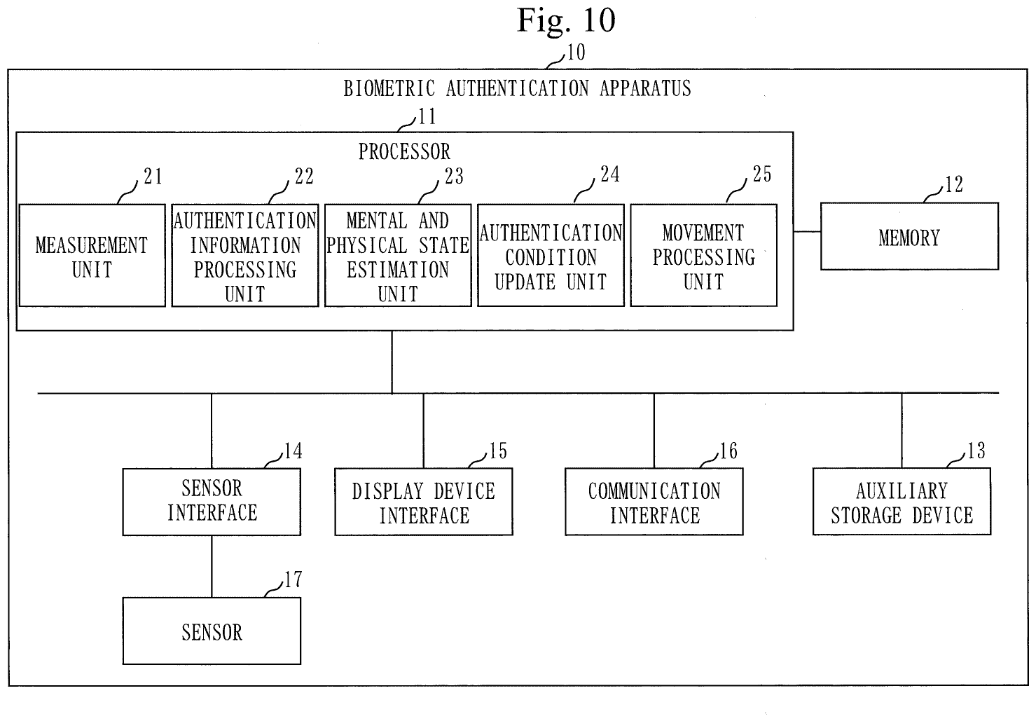

Referring to FIG. 10, the configuration of the biometric authentication apparatus 10 according to Embodiment 2 will be described.

The biometric authentication apparatus 10 differs from the biometric authentication apparatus 10 illustrated in FIG. 1 in that the biometric authentication apparatus 10 includes a movement processing unit 25 as a functional component. The function of the movement processing unit 25 is implemented by software or hardware, as with the other functional components.

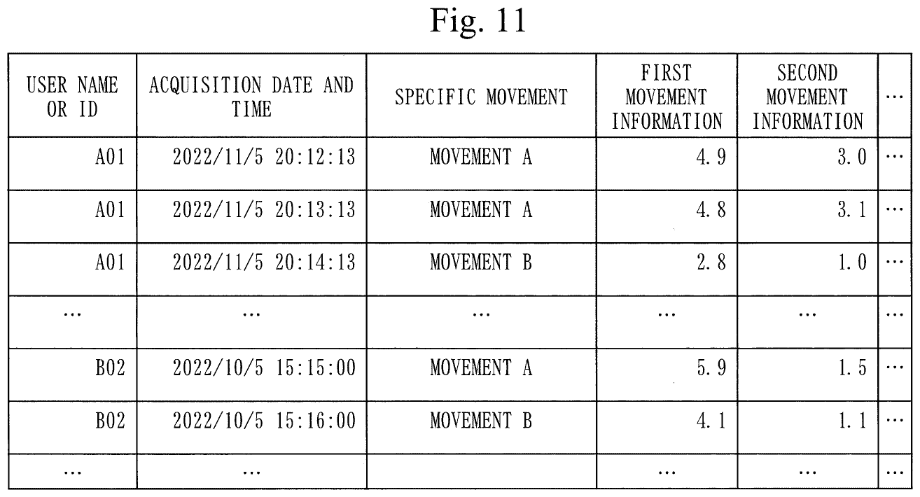

Also, as illustrated in FIG. 11, the database implemented by the memory 12 or the auxiliary storage device 13 stores, for each user and acquisition date and time, a specific movement, first movement information and second movement information generated from the biometric information, and the like. Information such as an identifier that represents the content of a movement is stored in the specific movement. The table illustrated in FIG. 11 may be combined into one table with at least one of the tables illustrated in FIG. 2 or 3.

### Description of Operation

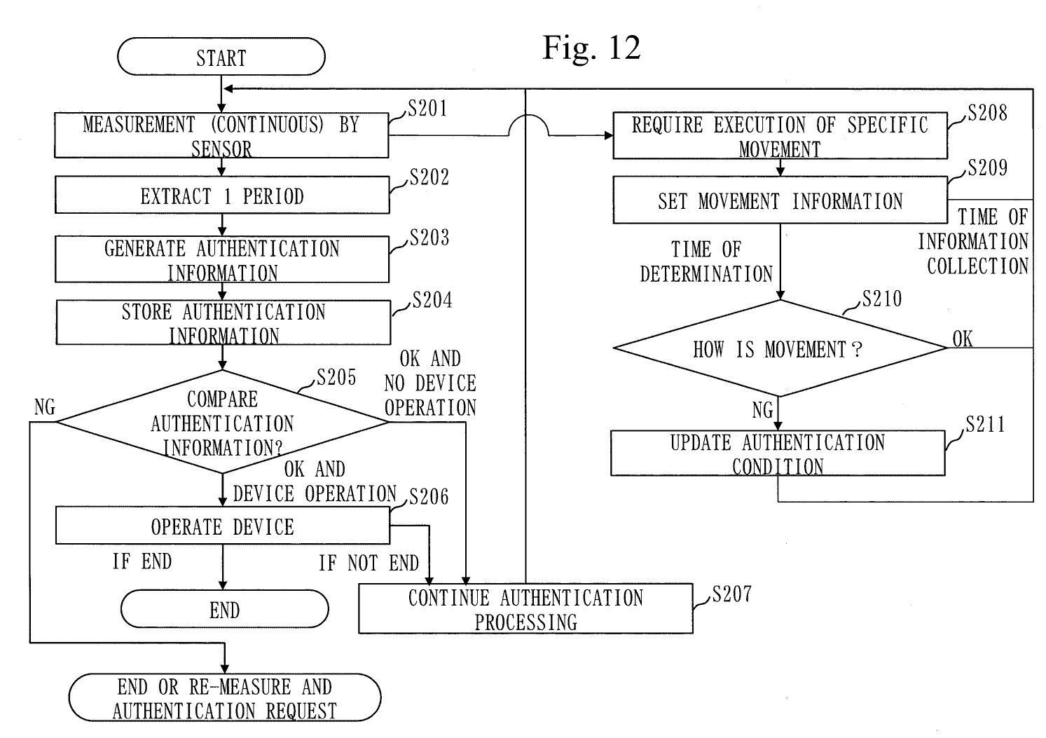

Referring to FIGS. 12 to 14, the operation of the biometric authentication apparatus 10 according to Embodiment 2 will be described.

An operation procedure of the biometric authentication apparatus 10 according to Embodiment 2 is equivalent to a biometric authentication method according to Embodiment 2. Also, a program that implements the operation of the biometric authentication apparatus 10 according to Embodiment 2 is equivalent to a biometric authentication program according to Embodiment 2.

Referring to FIG. 12, a processing flow of the biometric authentication apparatus 10 according to Embodiment 2 will be described.

The processes from steps S201 to S207 are the same as the processes from steps S101 to S107 in FIG. 5. The processes from steps S208 to S211 are executed at any timing. The processes from steps S208 to S211 may be executed periodically or at a specific timing.

### Step S208: Movement Requirement Process

The movement processing unit 25 requires the execution of the specific movement for the authentication subject. For example, the movement processing unit 25 performs, such as displaying a message and the like requiring the execution of the specific movement on a display device via the display device interface 15, and vibrating the biometric authentication apparatus 10. A requirement method is not limited to this and another method may be used.

The specific movement is, specifically, a change in posture or rotation of a specific part of the body such as a finger or arm. The specific movement may also be a change in posture of the whole body, such as lying down, sitting, or standing, or the like, and the content of the specific movement can be any. Also, although the movement that can be easily observed from the outside is described here as an example, a movement that is not necessarily easily observed from the outside, such as breathing, may also be the specific movement.

### Step S209: Movement Information Setting Process

The movement processing unit 25 sets the biometric information measured within a reference time as movement information after requiring the execution of the specific movement. Here, the movement processing unit 25 sets the biometric information measured within the reference time as the movement information regardless of whether or not the authentication subject has actually performed the specific movement. The movement processing unit 25 stores the movement information in the database as illustrated in FIG. 11.

### Step S210: Movement Estimation Process

The movement processing unit 25 determines whether or not the movement information stored in step S209 includes the biometric information resulting from the specific movement. When the biometric information resulting from the specific movement is included, the movement processing unit 25 considers that the specific movement has been executed. On the other hand, when the biometric information resulting from the specific movement is not included, the movement processing unit 25 considers that the specific movement has not been executed.

Then, when the specific movement has been executed, the movement processing unit 25 estimates that the authentication subject is a living body with intent. When the authentication subject is estimated to be the living body, the movement processing unit 25 returns the process to step S201. On the other hand, when the authentication subject is not estimated to be the living body, the movement processing unit 25 proceeds with the process to step S211.

### Step S211: Authentication Condition Update Process

The authentication condition update unit 24 changes the authentication condition used in step S205 depending on whether or not the authentication subject is estimated to be the living body. Here, since the authentication subject is estimated not to be the living body, the authentication condition update unit 24 tightens the authentication condition.

Then, the authentication condition update unit 24 returns the process to step S201.

In FIG. 12, instead of the processes from steps S108 to S111 in FIG. 5, the processes from steps S208 to S211 are executed. However, in addition to the processes from steps S108 to S111 in FIG. 5, the processes from steps S208 to S211 may also be executed. In other words, while the authentication condition is changed depending on the mental and physical state, the authentication condition may also be changed depending on whether or not the authentication subject is the living body.

Specific examples of the specific movement required in step S208, the biometric information measured when the specific movement is executed, and the method of changing the authentication condition in step S211, will be described.

Two examples of (c) and (d) will be described here. The biometric authentication apparatus 10 selects and uses one of (c) and (d), whichever is appropriate for the biometric information. Alternatively, the biometric authentication apparatus 10 may use (c) and (d) in combination.

In the two examples of (c) and (d), it is assumed that the processes illustrated from steps S201 to S205 are performed at the start of measurement or before specific device operation or the like, and when it is determined that the subject is a legitimate person, the authentication state is continued, and the measurement is repeated.

### (c) Finger Gripping Movement

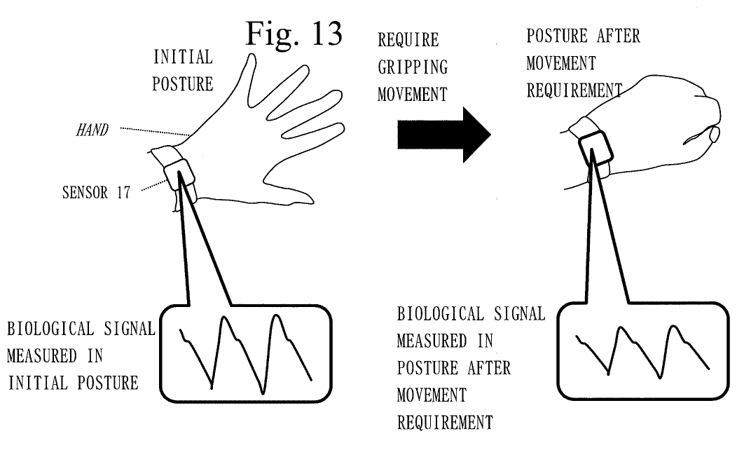

In (c), the movement processing unit 25 requires a finger gripping movement as the specific movement. In step S208, the movement processing unit 25 requires the movement of making a first form state from an open palm state, as the specific movement, as illustrated in FIG. 13. In step S209, regardless of whether or not the authentication subject has complied with the requirement, the movement processing unit 25 stores the biometric information measured in step S201 as the movement information in the database. In step S210, the movement processing unit 25 determines whether or not the movement information stored in the database includes the biometric information resulting from the finger gripping movement.

The movement processing unit 25 determines whether or not there is a change in the movement information. For example, the movement processing unit 25 determines whether or not there is a change in the amplitude illustrated in FIG. 13, in the movement information. The change in the amplitude is the biometric information resulting from the specific movement of the finger gripping movement. The amplitude of the biometric signal may be larger or smaller when the fingers are gripped compared to when the fingers are open, due to a change in the contact state of the sensor or the like. Therefore, there may be the change in the amplitude by performing the finger gripping movement.

When the change in the amplitude illustrated in FIG. 13 appears in the movement information, the movement processing unit 25 determines that the finger gripping movement has been executed and that the authentication subject is a living body (OK in step S210). Then, the movement processing unit 25 keeps the authentication condition as the initial condition. On the other hand, when no change in the amplitude illustrated in FIG. 13 appears in the movement information, the movement processing unit 25 determines that the finger gripping movement has not been executed and that there is a possibility that the authentication subject is not the living body (NG in step S210). Then, the movement processing unit 25 determines that it may be difficult to continue the authentication state as it is or to permit device operation, and proceeds with the process to step S211.

Then, in step S211, the authentication condition update unit 24 changes the authentication condition to a stricter condition than the initial condition. For example, the authentication condition update unit 24 reduces an allowable difference, which is a range that allows a difference between the template and the authentication information. Alternatively, when the device operation cannot be permitted, the authentication condition update unit 24 may terminate the authentication state.

### (d) Breathing Movement

In (d), the movement processing unit 25 requires a deep breathing movement as the specific movement. In step S208, the movement processing unit 25 requires the movement of taking a deep breath as the specific movement. In step S209, regardless of whether or not the authentication subject has complied with the requirement, the biometric information measured in step S201 is stored as the movement information in the database. In step S210, the movement processing unit 25 determines whether or not the movement information stored in the database includes the biometric information resulting from the deep breathing movement.

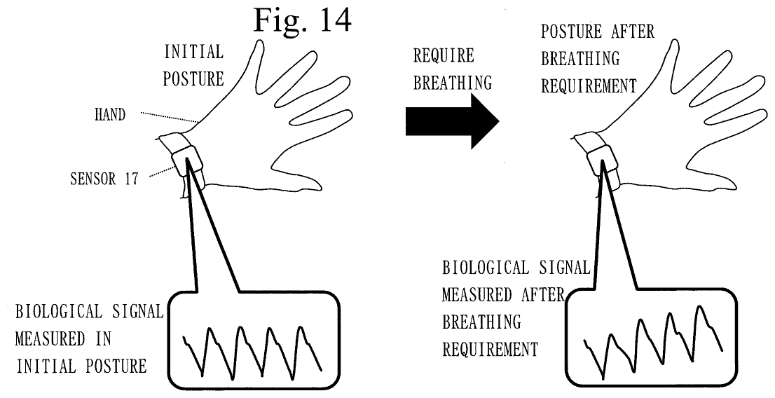

The movement processing unit 25 determines whether or not a rise or fall of the base line illustrated in FIG. 14 appears in the movement information. The rise or fall of the baseline is the biometric information that may be changed as a result of the deep breathing movement, which is the specific movement.

When the rise of the baseline illustrated in FIG. 14 appears in the movement information, the movement processing unit 25 determines that the deep breathing movement has been executed and that the authentication subject is a living body (OK in step S210). Then, the movement processing unit 25 keeps the authentication condition as the initial condition. On the other hand, when the rise of the baseline illustrated in FIG. 14 does not appear in the movement information, the movement processing unit 25 determines that the deep breathing movement has not been executed and that there is a possibility that the authentication subject is not the living body (NG in step S210). Then, the movement processing unit 25 determines that it may be difficult to continue the authentication state as it is or to permit device operation, and proceeds with the process to step S211.

Then, in step S211, the authentication condition update unit 24 changes the authentication condition to a stricter condition than the initial condition. For example, the authentication condition update unit 24 reduces an allowable difference, which is a range that allows a difference between the template and the authentication information. Alternatively, when the device operation cannot be permitted, the authentication condition update unit 24 may terminate the authentication state.

### Effects of Embodiment 2

As described above, the biometric authentication apparatus 10 according to Embodiment 2 requires a specific movement, and when biometric information resulting from the specific movement is measured, estimates that an authentication subject is a living body. Then, the biometric authentication apparatus 10 changes an authentication condition depending on whether or not the authentication subject has been estimated to be the living body. Thus, authentication is possible with the assurance that the authentication subject is the living body with intent. In other words, authentication is possible with the assurance that the authentication subject is not an artificial object.

### EMBODIMENT 3

Embodiment 3 differs from Embodiment 2 in that it is determined whether or not the authentication subject is a living body without questioning the intent of the authentication subject, and the authentication condition is changed. In Embodiment 3, this difference will be described, and the description of the same points will be omitted.

### Description of Configuration

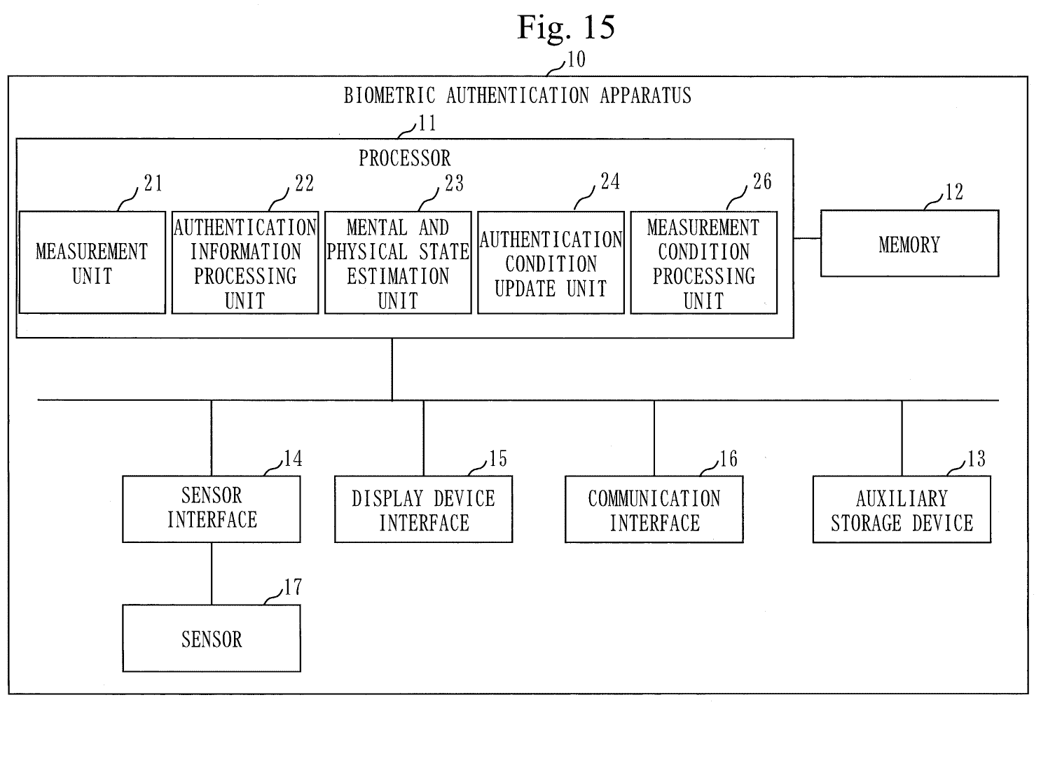

Referring to FIG. 15, the configuration of the biometric authentication apparatus 10 according to Embodiment 3 will be described.

The biometric authentication apparatus 10 differs from the biometric authentication apparatus 10 illustrated in FIG. 10 in that the biometric authentication apparatus 10 includes a measurement condition processing unit 26 instead of the movement processing unit 25 as a functional component. The function of the measurement condition processing unit 26 is implemented by software or hardware, as with the other functional components.

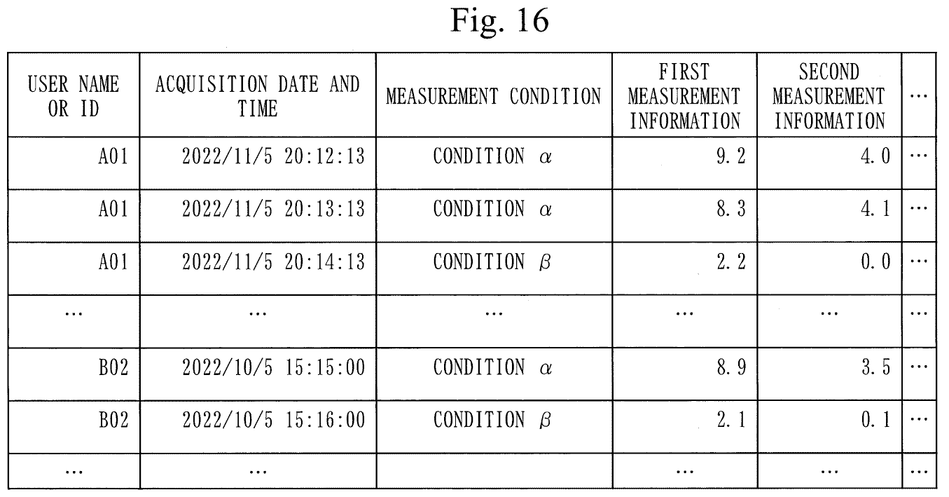

Also, as illustrated in FIG. 16, the database implemented by the memory 12 or the auxiliary storage device 13 stores, for each user and acquisition date and time, a measurement condition, first measurement information and second measurement information generated from the biometric information, and the like. Information such as an identifier that represents a measurement condition is stored in the measurement condition. The table illustrated in FIG. 16 may be combined into one table with at least one of the tables illustrated in FIG. 2, 3, or 11.

### Description of Operation

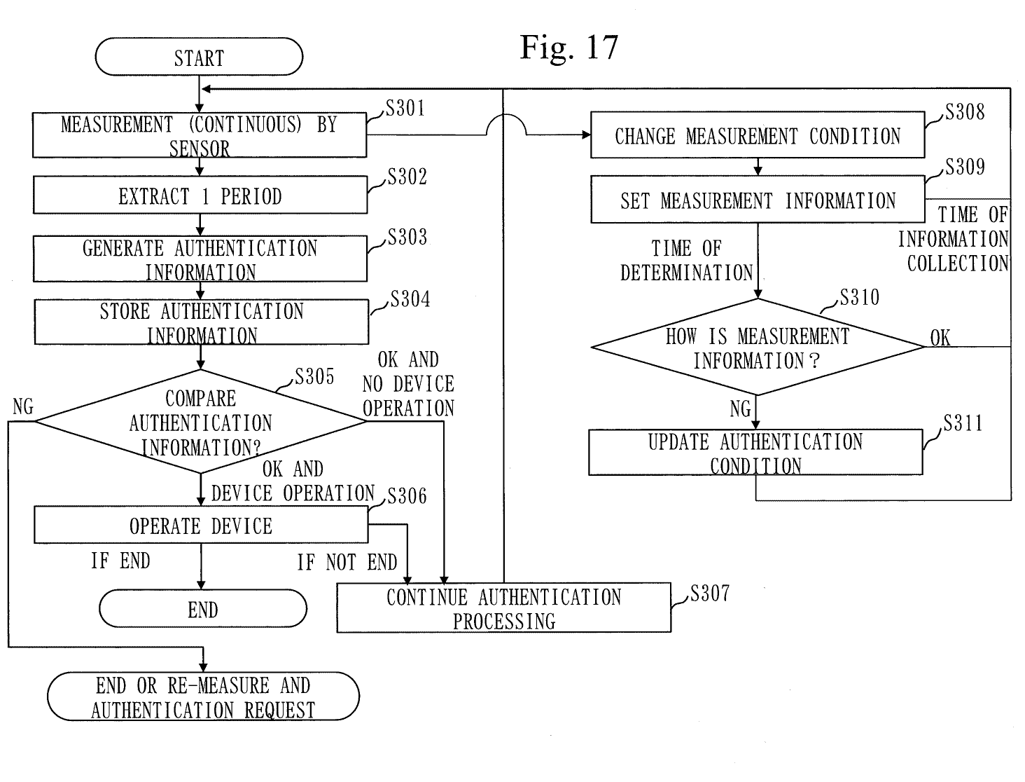

Referring from FIG. 17 to FIG. 19, the operation of the biometric authentication apparatus 10 according to Embodiment 3 will be described.

An operation procedure of the biometric authentication apparatus 10 according to Embodiment 3 is equivalent to a biometric authentication method according to Embodiment 3. Also, a program that implements the operation of the biometric authentication apparatus 10 according to Embodiment 3 is equivalent to a biometric authentication program according to Embodiment 3.

Referring to FIG. 17, a processing flow of the biometric authentication apparatus 10 according to Embodiment 3 will be described.

The processes from steps S301 to S307 are the same as the processes from steps S201 to S207 in FIG. 12. The processes from steps S308 to S311 are executed at any timing. The processes from steps S308 to S311 may be executed periodically or at a specific timing.

### Step S308: Measurement Condition Change Process

The measurement condition processing unit 26 changes the measurement condition of the biometric information.

The measurement condition is a condition that can be changed regardless of the intent of the authentication subject. Specific examples of the measurement condition will be described later.

### Step S309: Measurement Information Setting Process

The measurement condition processing unit 26 sets the biometric information measured within a reference time after changing the measurement condition, as measurement information. The measurement condition processing unit 26 stores the measurement information in the database as illustrated in FIG. 16.

### Step S310: Change Determination Process

The measurement condition processing unit 26 determines whether or not the biometric information corresponding to the changed measurement condition is included in the measurement information stored in step S309. When the biometric information corresponding to the changed measurement condition is included, the measurement condition processing unit 26 estimates that the authentication subject is a living body with intent.

When the authentication subject is estimated to be the living body, the measurement condition processing unit 26 returns the process to step S301. On the other hand, when the authentication subject is not estimated to be the living body, the measurement condition processing unit 26 proceeds with the process to step S311.

### Step S311: Authentication Condition Update Process

The authentication condition update unit 24 changes the authentication condition used in step S305 depending on whether or not the authentication subject is estimated to be the living body. Here, since the authentication subject is estimated not to be the living body, the authentication condition update unit 24 tightens the authentication condition.

Then, the authentication condition update unit 24 returns the process to step S301.

In FIG. 17, instead of the processes from steps S208 to S211 in FIG. 12, the processes from steps S308 to S311 are executed. However, in addition to the processes from steps S208 to S211 in FIG. 12, the processes from steps S308 to S311 may also be executed. In other words, the estimation of whether or not the authentication subject is the living body is made by requiring the specific movement, and the estimation may be made by changing the measurement condition.

Specific examples of the measurement condition set in step S308, the biometric information measured when the measurement condition is changed, and the method of changing the authentication condition in step S311, will be described.

Two examples of (e) and (f) will be described here. The biometric authentication apparatus 10 selects and uses one of (e) and (f), whichever is appropriate for the biometric information. Alternatively, the biometric authentication apparatus 10 may use (e) and (f) in combination.

In the two examples of (e) and (f), it is assumed that the processes illustrated from steps S301 to S305 are performed at the start of measurement or before specific device operation or the like, and when it is determined that the subject is a legitimate person, the authentication state is continued, and the measurement is repeated.

### (e) Reduction of Current Amount

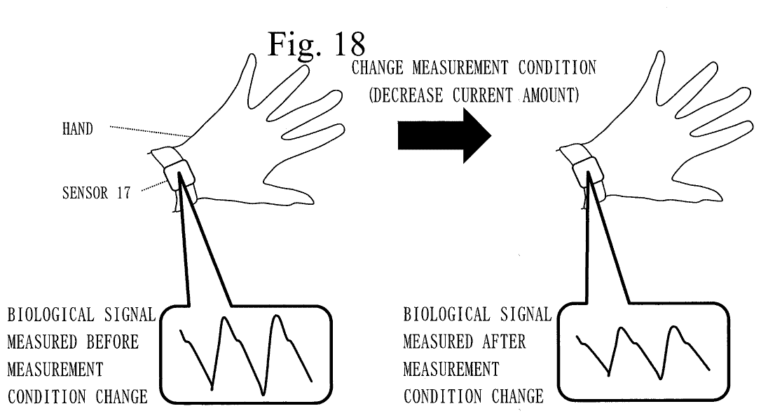

In (e), the measurement condition processing unit 26 reduces a current amount, which is one of the measurement conditions. In step S308, the measurement condition processing unit 26 reduces the current amount flowing to the sensor 17, which is one of the measurement conditions, as illustrated in FIG. 18. In step S309, the measurement condition processing unit 26 stores the biometric information measured in step S301 as the measurement information in the database. In step S310, the measurement condition processing unit 26 determines whether or not the measurement information stored in the database includes the biometric information in a case where the current amount is reduced.

The measurement condition processing unit 26 determines whether or not a change in the amplitude illustrated in FIG. 18 appears in the measurement information. The change in the amplitude is a change that may be reflected in the biometric information, as an amount of light emitted by a light source constituting the sensor changes depending on a change in the current amount. As the current amount decreases, the amplitude of the biometric signal may be small.

When the change in the amplitude illustrated in FIG. 18 appears in the measurement information, the measurement condition processing unit 26 determines that the authentication subject is a living body (OK in step S310). Then, the measurement condition processing unit 26 keeps the authentication condition as the initial condition. On the other hand, when the change in the amplitude illustrated in FIG. 18 does not appear in the measurement information, the measurement condition processing unit 26 determines that there is a possibility that the authentication subject is not the living body (NG in step S310). Then, the measurement condition processing unit 26 determines that it may be difficult to continue the authentication state as it is or to permit device operation, and proceeds with the process to step S311.

Then, in step S311, the authentication condition update unit 24 changes the authentication condition to a stricter condition than the initial condition. For example, the authentication condition update unit 24 reduces an allowable difference, which is a range that allows a difference between the template and the authentication information. Alternatively, when the device operation cannot be permitted, the authentication condition update unit 24 may terminate the authentication state.

### (f) Change of Light Source Wavelength

In (f), the measurement condition processing unit 26 changes the wavelength (light color) of the light source, which is one of the measurement conditions. In step S308, the measurement condition processing unit 26 switches a switch or the like on hardware mounted with a plurality of light sources such as LEDs, to turn the light source to be used itself into another. LED is an abbreviation for Light-Emitting Diode. While the light source that can change a wavelength is in use, the measurement condition processing unit 26 may change the wavelength. In step S309, the measurement condition processing unit 26 stores the biometric information measured in step S301 as the measurement information in the database. In step S310, the measurement condition processing unit 26 determines whether or not the measurement information stored in the database includes the biometric information in a case where the wavelength of the light source is changed.

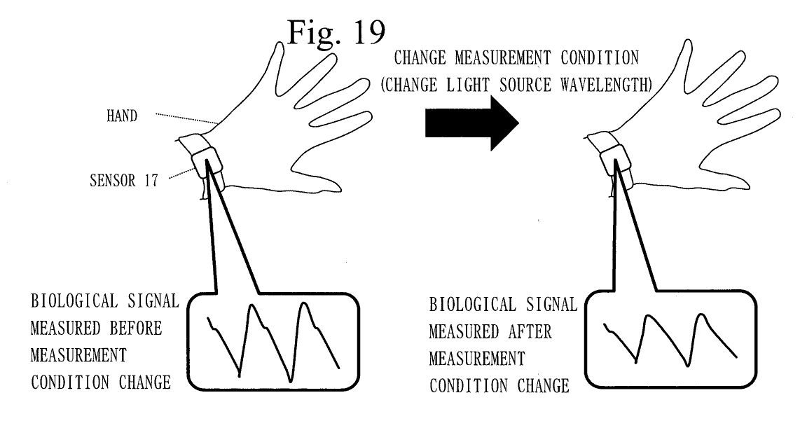

The measurement condition processing unit 26 determines whether or not a decrease in the amplitude illustrated in FIG. 19 or disappearance of inflection points in the waveform appears in the measurement information. The decrease in the amplitude and the disappearance of inflection points in the waveform are changes in the biometric information that may be reflected depending on the change in the wavelength of the light source. As the wavelength of the light source is changed, the amplitude of the biometric signal decreases, and the inflection points in the waveform disappear. Therefore, by changing the wavelength of the light source, the amplitude decreases. Also, the disappearance of inflection points in the waveform occurs.

When the decrease in the amplitude illustrated in FIG. 19 or the disappearance of inflection points in the waveform appears in the measurement information, the measurement condition processing unit 26 determines that the authentication subject is a living body (OK at step S310). Then, the measurement condition processing unit 26 keeps the authentication condition as the initial condition. On the other hand, when neither appears in the measurement information, the measurement condition processing unit 26 determines that there is a possibility that the authentication subject is not the living body (NG at step S310). Then, the measurement condition processing unit 26 determines that it may be difficult to continue the authentication state as it is or to permit device operation, and proceeds with the process to step S311.

Then, in step S311, the authentication condition update unit 24 changes the authentication condition to a stricter condition than the initial condition. For example, the authentication condition update unit 24 reduces an allowable difference, which is a range that allows a difference between the template and the authentication information. Alternatively, when the device operation cannot be permitted, the authentication condition update unit 24 may terminate the authentication state.

### Effects of Embodiment 3

As described above, the biometric authentication apparatus 10 according to Embodiment 3 changes a measurement condition, and when biometric information corresponding to the changed measurement condition is measured, estimates that an authentication subject is a living body. Then, the biometric authentication apparatus 10 changes an authentication condition depending on whether or not the authentication subject has been estimated to be the living body. Thus, authentication is possible with the assurance that the authentication subject is the living body without questioning the intent of the authentication subject. In other words, authenticate is possible with the assurance that the authentication subject is not an artificial object.

It should be noted that the term “unit” in the above description may be replaced with “circuit,” “process,” “procedure,” “processing,” or “processing circuitry.”

The embodiments and modifications of the present disclosure have been described above. Among these embodiments and modifications, some may be practiced by combination. Alternatively, one or some of these embodiment and modifications may be practiced partly. The present disclosure is not limited to the above embodiments and modifications, and various modifications can be made as necessary.

### REFERENCE SIGNS LIST

10: biometric authentication apparatus; 11: processor; 12: memory; 13: auxiliary storage device; 14: sensor interface; 15: display device interface; 16: communication interface; 17: sensor; 21: measurement unit; 22: authentication information processing unit; 23: mental and physical state estimation unit; 24: authentication condition update unit; 25: movement processing unit; 26: measurement condition processing unit.

1. A biometric authentication apparatus comprising:
processing circuitry:
to measure biometric information of an authentication subject by a sensor;
to generate from the acquired biometric information, authentication information that varies depending on the individual living body, and to determine the propriety of authentication based on whether or not the authentication information satisfies an authentication condition;
to generate from the biometric information, mental and physical information for estimating a mental and physical state of the authentication subject, and to estimate the mental and physical state form the mental and physical information;
when the estimated mental and physical state is worse than a criterion, to change the authentication condition to a stricter condition;
to remeasure the biometric information after the authentication condition is changed to a stricter condition; and
to generate the authentication information from the remeasured biometric information after determining that the authentication subject can be authenticated, and to redetermine the propriety of authentication using the updated authentication condition.

2. The biometric authentication apparatus according to claim 1, wherein
the processing circuitry generates the mental and physical information at an observation interval, and estimates the mental and physical state from the mental and physical information generated at an observation time.

3. The biometric authentication apparatus according to claim 2, wherein
the processing circuitry estimates the mental and physical state from a change in the mental and physical state generated at the observation interval.

4. The biometric authentication apparatus according to claim 1, wherein
the processing circuitry generates information that represents a physical condition of the authentication subject as the mental and physical information.

5. The biometric authentication apparatus according to claim 1, wherein
the processing circuitry generates information that represents an attachment state of the sensor as the mental and physical information.

6. The biometric authentication apparatus according to claim 1, wherein
the processing circuitry changes the authentication condition depending on whether or not the authentication subject has been estimated to be a living body.

7. The biometric authentication apparatus according to claim 6, wherein
when biometric information resulting from a specific movement has been measured, the processing circuitry estimates the authentication subject to be a living body, and
the processing circuitry changes the authentication condition depending on whether or not the authentication subject has been estimated to be the living body.

8. The biometric authentication apparatus according to claim 7, wherein
the processing circuitry requires execution of the specific movement to the authentication subject, and when the biometric information resulting from the specific movement is measured within a reference time from the requirement of the execution of the specific movement, estimates that the authentication subject is a living body.

9. The biometric authentication apparatus according to claim 6, wherein
the processing circuitry changes a measurement condition, and when biometric information depending on the changed measurement condition is measured, estimates that the authentication subject is a living body, and
the processing circuitry changes the authentication condition depending on whether or not the authentication subject has been estimated to be the living body.

10. The biometric authentication apparatus according to claim 7, wherein
the processing circuitry changes a measurement condition, and when biometric information depending on the changed measurement condition is measured, estimates that the authentication subject is a living body, and
the processing circuitry changes the authentication condition depending on whether or not the authentication subject has been estimated to be the living body.

11. The biometric authentication apparatus according to claim 8, wherein
the processing circuitry changes a measurement condition, and when biometric information depending on the changed measurement condition is measured, estimates that the authentication subject is a living body, and
the processing circuitry changes the authentication condition depending on whether or not the authentication subject has been estimated to be the living body.

12. A biometric authentication method comprising:
measuring biometric information of an authentication subject by a sensor;
generating from the biometric information, authentication information that varies depending on the individual living body, and determining the propriety of authentication based on whether or not the authentication information satisfies an authentication condition;
generating from the biometric information, mental and physical information for estimating a mental and physical state of the authentication subject, and estimating the mental and physical state form the mental and physical information;
when the estimated mental and physical state is worse than a criterion, changing the authentication condition to a stricter condition;
remeasuring the biometric information after the authentication condition is changed to a stricter condition; and
generating the authentication information from the remeasured biometric information after determining that the authentication subject can be authenticated, and redetermining the propriety of authentication using the updated authentication condition.

13. A non-transitory computer readable medium storing a biometric authentication program for causing a computer to function as a biometric authentication apparatus to execute:
a measurement process to measure biometric information of an authentication subject by a sensor;
an authentication information process to generate from the biometric information acquired by the measurement process, authentication information that varies depending on the individual living body, and to determine the propriety of authentication based on whether or not the authentication information satisfies an authentication condition;
a mental and physical state estimation process to generate from the biometric information, mental and physical information for estimating a mental and physical state of the authentication subject, and to estimate the mental and physical state form the mental and physical information; and
an authentication condition update process, when the mental and physical state estimated by the mental and physical state estimation process is worse than a criterion, to change the authentication condition to a stricter condition, wherein
the measurement process remeasures the biometric information after the authentication condition is changed to a stricter condition by the authentication condition update process, and
the authentication information process generates the authentication information from the biometric information remeasured by the measurement process after determining that the authentication subject can be authenticated, and redetermines the propriety of authentication using the authentication condition updated by the authentication condition update process.
